(19) United States
(12) Patent Application Publication
(10) Pub. No.: US 2007/0286754 A1
(43) Pub. Date: Dec. 13, 2007

(54) Circulation pump and method for production of a circulation pump

(75) Inventor: Karsten Laing, Althuette (DE)

Correspondence Address: Lipsitz & McAllister, LLC, 755 MAIN STREET, MONROE, CT, 06468, US

(73) Assignees: Karsten Laing, Althuette (DE); Oliver Laing, Stuttgart (DE); Birger Laing, Marbach (DE)

(21) Appl. No.: 11/807,203

(22) Filed: May 24, 2007

Related U.S. Application Data
(63) Continuation of application No. PCT/EP2005/011860, filed on Nov. 5, 2005.

(30) Foreign Application Priority Data
Nov. 26, 2004 (DE) 10 2004 058 591

(51) Int. Cl. F04B 17/03; B23P 15/00

(52) U.S. Cl. 417/423.14; 29/888.02

(57) ABSTRACT

To provide a circulation pump comprising a housing, in which a pump space is arranged, a pump impeller, which can be rotated about a rotational axis, and an electric motor to drive the pump impeller, that can be produced simply and economically, it is proposed that the housing have a receiving space for the electric motor.

This application is a continuation of international application number PCT/EP2005/011860 filed on Nov. 5, 2005.

The present disclosure relates to the subject matter disclosed in international application number PCT/EP2005/011860 of Nov. 5, 2005 and German application number 10 2004 058 591.1 of Nov. 26, 2004, which are incorporated herein by reference in their entirety and for all purposes.

### BACKGROUND OF THE INVENTION

The invention relates to a circulation pump, comprising a housing, in which a pump space is arranged, a pump impeller which can be rotated about a rotational axis and an electric motor to drive the pump impeller.

The invention also relates to a method for producing a circulation pump.

A circulation pump is known from U.S. Pat. No. 6,082,976 A, which has a pump housing with a pump space and which has a motor with a motor housing, which borders the pump housing. The motor is pressed against one side of the pump housing, the pump housing being clamped between a distributor pipe and the motor.

### SUMMARY OF THE INVENTION

In accordance with the present invention, a circulation pump is provided, which can be produced simply and economically.

In accordance with an embodiment of said circulation pump the housing has a receiving space for the electric motor.

The circulation pump in accordance with the invention can be produced in a simple manner: no separate housings have to be provided for the pump space and to receive the electric motor, but a single interconnected housing may form the pump space and the receiving space for the electric motor. The electric motor can be fixed in a simple manner.

The solution according to the invention is, in particular, advantageous in connection with electric motors with a low axial overall height, the overall height of the electric motor being substantially determined by a rotor. In an electric motor of this type with a low axial overall height, the heat can be removed, in particular from a stator to a liquid to be pumped. No separate part housing then has to be provided for the electric motor, which has to be fixed (externally) to the pump housing.

The electric motor may be braced between at least two opposing contact faces. No screws or bolts or the like thus have to be provided to fix the electric motor in the housing. Thus, the housing configuration is simplified, on the one hand, as no engagement regions have to be provided for screws or the like. On the other hand, production is simplified.

In a production of the housing from plastics material, an optimised shaping can be provided for it.

In particular, the housing has an axial extent with respect to the rotational axis of the electric motor to form the receiving space for the electric motor. A receiving space can thus be provided to receive the electric motor.

It is quite particularly advantageous if the housing is produced from a plastics material. Possible materials are, for example, PPS or PA6.6. The housing can thus be produced integrally, for example by an injection moulding method. Plastics materials can easily be shaped. Thus, the design required for a high degree of efficiency can be adjusted, in particular for the pump space.

The housing is advantageously configured in one piece. The production of the components for the pump is thus simplified and assembly is simplified.

In particular, the pump space and the receiving space for the electric motor are axially arranged one after the other in the housing. The circulation pump can thus be configured in a space-saving manner and the pump impeller can be driven directly by the electric motor.

It is quite particularly advantageous if a fixing device is provided at least for axially fixing the electric motor in the housing. The fixing device ensures a substantially play-free fixing of the electric motor in the housing.

In particular, the electric motor is fixed by means of the fixing device to the housing by bracing.

It is favourable if the fixing device has one or more holding elements, which are fixed to the housing and by means of which the electric motor is held in position. The electric motor may be axially positioned and fixed and/or, if necessary at all, radially positioned and fixed by means of the at least one holding element. The at least one holding element provides one or more contact faces, which block an axial mobility of the electric motor at least in an axial direction. The electric motor can thus be held clamped or braced in the housing. The at least one holding element can absorb the static pressure of the system and the dynamic pressure, caused by the pumping function.

It is quite particularly advantageous if the at least one holding element is fixed on the housing by means of a housing periphery or at least one interconnected part region of a housing periphery. The pressure acting on the housing can thus be absorbed in a structurally simple manner. This fixing can be achieved, for example, by a thread connection of the at least one holding element to the housing, by a clamping device, for example with snap closure connections or by a bayonet lock connection. No receiving space region for screws or bolts thus has to be provided in the housing. Corresponding housing walls can be configured so as to be thin-walled. The housing can thus be produced in a manner “suitable for plastics material”, in other words, plastics material can be used to produce the housing. With regard to an axial fixing, no substantial shear stresses occur in the housing when the holding element is fixed by means of a housing periphery. This in turn makes it possible to use a plastics material to produce the housing.

In one embodiment, it is provided that the at least one holding element is fixed to the housing along the entire periphery. This fixing takes place, for example, by means of a thread connection, in that, for example, a holding element is screwed directly into the housing or a retainer nut as the holding element fixes the electric motor.

In one embodiment, the at least one holding element is provided with a thread and the housing is provided with a corresponding thread. The holding element can thus be screwed to the housing by means of a screw connection, the holding element itself forming the screw, for example, and the housing the counter piece.

For example, the at least one holding element is provided with an external thread and the housing is provided with an internal thread. The holding element is then configured as a type of plug, which can be fixed to the housing in order to close it by means of a thread connection.

It may be provided that the at least one holding element projects into the housing. For example, the holding element may be configured in the manner of a plug, the plug projecting into the housing and thus acting on the electric motor in order to brace it axially. It is also possible for the holding element to be part of the electric motor and, in particular, formed by means of the motor housing of the electric motor. The holding element itself is then in turn configured in such a way that it fixes the electric motor in the housing “from within”, for example by means of recess/tongue connections or groove/pin connections.

It is also possible for the at least one holding element to have an internal thread and the housing to have an external thread. A holding element can thus be formed as a retainer nut, for example, by means of which the electric motor is axially fixed.

It is particularly advantageous when the electric motor has one or more contact faces for the at least one holding element. The holding element may act on a corresponding contact face in order to thus hold the electric motor axially fixed in the housing. In particular, the electric motor can be held clamped in the housing.

In one embodiment, it is provided that the at least one contact face projects over the housing. A holding element may then be used, which does not project into the housing. For example, a holding element can be configured as a retainer nut.

It is basically possible for the at least one holding element to be a separate component from the electric motor. For example, the holding element is configured as a type of plug, which is screwed into the housing, so the plug acts on the electric motor, and in particular a motor housing of the electric motor in order to fix the latter in the housing of the circulation pump. (The motor housing of the electric motor then has no fixing function apart from providing contact faces for the at least one holding element. The motor housing of the electric motor is substantially used to “hold together” the motor components, in order to be able to handle the electric motor as a unit.)

Alternatively, it is possible for the at least one holding element to be arranged on the electric motor. No additional component is then necessary for fixing the electric motor in the housing.

In particular, the at least one holding element is then formed by means of a motor housing of the electric motor.

It may be provided that the at least one holding element is fixed by means of a clamping device in the housing. In particular, the clamping device comprises one or more snap closure connections. In this manner, for example, a circulation pump may be provided, in which a housing cover, which is formed by means of a holding element, can no longer be detached without destruction.

It may be provided that the clamping device has at least one tongue, which is arranged on the at least one holding element and/or the housing, and at least one adapted recess, which is arranged on the housing and/or the at least one holding element, so by projection of the at least one tongue into the associated recess, the at least one holding element is fixed on the housing at least axially. A snap closure connection can thus be provided. In particular, a tongue of this type is elastically arranged and configured in such a way that the holding element can be inserted into the housing. When the tongue reaches into the region of the associated recess, it is pressed into the recess because of the elastic force and projects thereinto. This projecting in blocks the further movement of the holding element such that the holding element is positioned and fixed by the “automatic” production of the snap closure connection on insertion of the holding element and thus the electric motor is also positioned and fixed.

It may also be provided that the at least one holding element is fixed by means of a bayonet connection to the housing. In a bayonet connection, a pin/groove device is provided, one or more pins being arranged on the housing and/or a holding element and one or more adapted grooves being provided on the holding element and/or the housing. The grooves provide, when the pins are inserted, the movement capabilities for the holding element and also its end position.

It may be provided that one or more seals are arranged between the at least one holding element and the housing. The housing interior on the holding element, which is also used as a cover to close the housing, can thus be protected before the entry of liquids into the housing interior. A corresponding circulation pump can be used, in particular, as an immersion pump.

It is quite particularly advantageous if a contact face is arranged on the housing to support the electric motor. Between a contact face of this type and a holding element, the electric motor may be held braced in the housing. A contact face of this type forms a counter bearing for the electric motor.

A corresponding circulation pump can be produced in a simple manner when the contact face is formed on a shoulder in an interior of the housing. This shoulder can be integrally co-produced during production of the housing.

It is favourable if the receiving space of the housing is adapted to the electric motor in such a way that it is radially positioned and fixed by resting on interior housing wall regions. No screw connections or the like are required, in particular, for a radial fixing of this type. It is basically also possible for an insert to be provided for an intermediate space between the electric motor and the housing, by means of which the electric motor is radially positioned. An insert of this type is, in particular, produced from a plastics material.

It is favourable if the electric motor has a spherically mounted rotor. A corresponding electric motor has a high degree of quiet running. It can be configured with a low axial overall height.

In this connection, it is also favourable if the rotor is configured to generate a magnetic field. A corresponding electric motor is described in DE 102 45 015 A1, US 2003/0222527 A1, EP 1 416 607 A2 and US 2004/0119371 A, to which reference is expressly made.

In particular, it is advantageous if the rotor is spherically configured facing a stator. An electric motor with a low axial overall height can thus be constructed, the axial overall height thereof being substantially determined by the height of the rotor.

For the same reason, it is favourable if the stator is spherically configured facing the rotor.

A low axial overall height can be achieved when a magnetic return body of the stator annularly surrounds the rotor. The stator can thus be positioned completely adjacent to the pumping space. This in turn allows heat to be also removed from the stator directly by means of the liquid flowing through the circulation pump. This in turn means that the housing is thermally less loaded in the region of the electric motor. A plastics material can thus be used to produce the housing in the region of the electric motor. This in turn allows an integral housing for the circulation pump (which also receives the electric motor) to be produced from a plastics material.

The magnetic return body may be produced from a pressed powder material. A corresponding electric motor is disclosed in EP 1 416 607 A2 and US 2004/0119371 A1, to which reference is expressly made.

It is favourable if a height of the stator substantially corresponds to the height of the rotor or has a smaller height than the height of the rotor. The height of the electric motor is then substantially determined by the height of the rotor. The advantages described above, that, for example, heat can be removed from the stator by means of the pumping liquid, are thus produced.

In particular, it is favourable if a rotor and a stator of the electric motor are configured adapted in such a way that an axial magnetic holding force, which holds the rotor on a spherical bearing, is greater than a maximum axial counterforce. It can be achieved by means of the corresponding adjustment of the magnetic holding forces that, even when the motor is switched off, the rotor is held magnetically on the spherical bearing, in other words does not lift up therefrom. A corresponding electric motor is described in DE 102 45 015 A1 and US 2003/0222527 A1, to which reference is expressly made.

It is quite particularly advantageous if the electric motor is arranged and configured in such a way that heat can be removed from it by means of the liquid to be pumped. The thermal loading of the housing in the region of the electric motor is thus sharply reduced. A plastics material can thus in turn be used to produce the housing.

In particular, a stator of the electric motor is in thermal contact with the pump space in order to be able to remove heat by means of the pumping liquid.

In accordance with the present invention, a method for producing a circulation pump is provided, which can be implemented in a simple and economical manner.

In accordance with an embodiment of the invention, a housing with a pump space and a receiving space for an electric motor is produced and the electric motor is inserted into this housing.

The method according to the invention already has the advantages described in conjunction with the circulation pump according to the invention.

Further advantageous configurations have also already been described in conjunction with the circulation pump according to the invention.

In particular, the housing is produced from a plastics material. A “total housing”, which has a pump space part and a receiving space part, can thus be integrally produced. The housing can be produced in such a way that it is optimised with respect to its properties. For example, the pump space is integrally produced in the housing in such a way that a high degree of efficiency is produced. For example, contact faces are also produced in the housing, on which an electric motor can be supported for the clamping or braced holding thereof in the housing.

It is favourable if the electric motor is axially fixed by means of one or more holding elements, the at least one holding element being fixed to the housing. The corresponding electric motor can thus be produced in a simple manner. A holding element for fixing the electric motor can thus also be configured, for example, as a cover to close a housing interior.

In one embodiment, the housing is closed by means of the at least one holding element, i.e. the receiving space is closed relative to the outer space. The holding element, which is configured, for example, as a stopper, then forms a housing cover.

It is quite particularly advantageous if the at least one holding element is fixed to the housing by means of a peripheral region of the housing. An axial positioning and fixing of the holding element and therefore of the electric motor in the housing can thus be achieved in a simple manner. However, with the fixing around a peripheral region, the shear stresses may be kept low or no shear stresses occur. This in turn makes it possible for the housing in the fixing region to be configured with relatively thin walls, which in turn allows the use of plastics materials.

It may be provided that the electric motor is radially positioned in the housing by resting on the housing. In particular, a simultaneous radial fixing then also takes place. The corresponding circulation pump can then be produced in a simple manner as, when inserting the electric motor, automatic alignment, positioning and fixing of the electric motor in the radial direction are ensured.

The following description of preferred embodiments is used in conjunction with the drawings for a closer description of the invention.

### BRIEF DESCRIPTION OF THE DRAWINGS

FIG. 1 shows a sectional view of a first embodiment of a circulation pump according to the invention;

FIG. 2 shows a sectional view of a second embodiment of a circulation pump according to the invention;

FIG. 3 shows an enlarged view of the region A in FIG. 2;

FIG. 4 shows a sectional view of a third embodiment of a circulation pump according to the invention;

FIG. 5 shows an enlarged view of the region B according to FIG. 4;

FIG. 6 shows a sectional view of a fourth embodiment of a circulation pump according to the invention; and

FIG. 7 shows a sectional view along the line 7-7 according to FIG. 6.

### DETAILED DESCRIPTION OF THE INVENTION

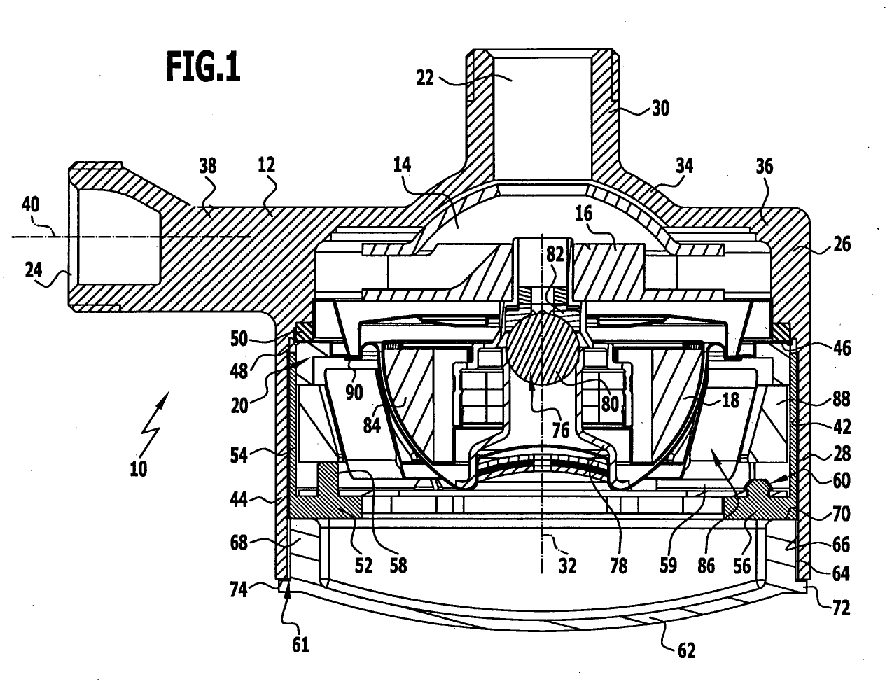

A first embodiment of a circulation pump according to the invention, which is shown in FIG. 1 and designated 10 there, comprises a housing 12, in which a pump space 14 is formed.

A pump impeller 16 is rotatably arranged in the pump space 14. The pump impeller 16 is non-rotationally connected to a rotor 18 of an electric motor 20.

The pump space 14 is in fluid connection with an inlet connector 22 and a pressure connector 24. Liquid is introduced into the pump space 14 by means of the inlet connector 22 and liquid guided through the pump space 14 can be removed by means of the pressure connector 24.

The housing 12 has a pump space part 26 and an electric motor part 28. The pump space part 26 of the housing 12 comprises a connecting piece 30, on which the inlet connector 22 is formed. The connecting piece 30 extends, for example, in parallel or coaxially to a rotational axis 32 of the electric motor 20.

In the embodiment shown, the connecting piece 30 is connected by means of a dome-shaped region 34 to a cross-sectionally substantially rectangular housing region 36.

A connecting piece 38 is also provided and extends in a transverse direction 40 to the rotational axis 32; the transverse direction 40 is perpendicular to the rotational axis 32, for example. The pressure connector 24 is arranged or formed on the connecting piece 38. The pressure connector 24 and the inlet connector 22, are, in particular, offset with respect to one another such that their axes do not intersect (centreline-offset arrangement).

The connecting piece 38, the dome-shaped region 34 and the connecting piece 30 are, in particular, connected to one another in one piece.

In the housing 12, a receiving space 42 for the electric motor 20, with respect to the rotational axis 32, axially follows the pump space 14. The electric motor 20 is largely arranged in this receiving space 42.

To form the receiving space 42, the housing 12 in the electric motor part 28, comprises a wall 44. This wall 44 is, in particular, cylindrical with an axis coaxial to the rotational axis 82. The receiving space 42 for the electric motor 20 therefore has a cylindrical design.

The wall 44 is connected in one piece to the pump region 26 of the housing 12. The housing 12 is thus configured in one piece, the pump space 14 being arranged and the electric motor 20 being received therein.

A wall thickness of the wall 44 is smaller than a corresponding wall thickness of the housing 12 in the pump region 26. A step-shaped shoulder 46 is thus formed at the transition from the pump space 14 to the receiving space 42. An in particular annular contact face 48 is provided by this shoulder 46. The electric motor 20 can be placed directly or via a seal 50 on this contact face 48.

The electric motor 20 is configured with a motor housing 52 in such a way that it can be positioned radially in the receiving space 42. The motor housing 52 is used to hold together the motor components, so the electric motor 20 can be handled as a unit. It is, for example, produced from a plastics material. It has, for example, a cylindrical side wall 54, which protrudes over a base 56. The side wall 54 surrounds the stator 88 laterally. The base 56 rests, at least partially, by means of one or more contact elements 58 on a stator 86.

It may be provided that a circuit board 59 is held, for example, by means of one or more snap pin connections 60 on the base 56 and therefore on the motor housing 52. Electronic components are arranged on the circuit board 59.

The circuit board 59 can be fixed to the motor housing 52 by means of the at least one snap pin connection 60.

The electric motor 20 with its motor housing 52 has a cross-sectional diameter transverse to the rotational axis 32, which corresponds substantially to the internal diameter of the receiving space 42.

During production of the circulation pump 10, the electric motor 20 with its motor housing is pushed from an open end of the housing 12 into the receiving space 42. The displaceability into the pump space 14 is blocked by the shoulder 46: when the electric motor 20 rests on the contact face 48 of the shoulder 46, it cannot be displaced further in the direction of the pump space 14. The motor housing 52 thus ensures a radial positioning and therefore a radial fixing of the electric motor 20 in the receiving space 42.

To fix the electric motor 20 in the housing 12, a fixing device 61 is provided. This is used for the axial positioning and fixing of the electric motor 20 in the housing 12. It can also be used for radial positioning and fixing; in the circulation pump 10 the motor housing 52 takes on the task of the radial positioning and fixing of the electric motor 20.

For the axial fixing of the electric motor 20 with respect to the end of the housing 12, which is open during the insertion of the electric motor 20, a holding element 62 is provided, which is fixed on the housing 12. The holding element 62 blocks a movement of the electric motor 20 away from the pump space 14, so the electric motor is also axially fixed in the housing 12. The holding element 62 thus acts on the electric motor 20 in order to hold it braced or clamped in the axial direction in the housing 12.

In the circulation pump 10, the holding element 62 is configured in the manner of a stopper with an external thread 64, which is adapted to an internal thread 66 of the housing 12 in the electric motor region 28. The holding element 62 can thus be screwed in the housing 12.

The holding element 62 is also used as a cover for closing the housing 12 on the receiving space 42.

The external thread 64 of the holding element 62 is configured on an annular holding region 68. This holding region 68 has an end annular face 70. By means of this annular face 70, the holding element 62 acts on the motor housing 52 and therefore in turn on the electric motor 20. The electric motor 20 can be pushed against the contact face 48 of the shoulder 46 by means of the annular face 70 and can therefore be held braced.

The holding element 62 may have an annular flange 72, an external diameter of this flange 72 being greater than an internal diameter of the receiving space 42. The flange 72 can thus overlap an end face 74 of the housing 12 in the electric motor part 28 (which is annular), to ensure a seal.

The electric motor 20 has a spherical bearing 76, by means of which the rotor 18 is spherically mounted. The spherical bearing 76 comprises a holding column 78, on which a spherical sliding body 80 is seated. The sliding body 80 is, in particular, produced from a ceramic material.

A bearing shell 82 adapted to the spherical sliding body 80 is non-rotationally seated on the rotor 18.This bearing shell slides on the sliding body 80 on rotation of the rotor 18.

In one embodiment, the rotor 18 generates a magnetic field. One or more permanent magnets 84 are arranged thereon. The rotor 18 is spherically configured facing a stator 86. The stator 86 is also spherically configured facing the rotor 18.

A magnetic return body 88 of the stator 86 surrounds the rotor 18 annularly, it being possible for this return body 88 to be configured, in particular, closed. An axial height of the stator 86 substantially corresponds to the height of the rotor 18 or is smaller.

In particular, the rotor 18 and the stator 86 are configured adapted in such a way that an axial magnetic holding force, which holds the rotor 18 on the spherical bearing 76, is greater than a maximum axial counterforce. It is thus achieved that even when the motor is switched off, the rotor 18 is held magnetically on the spherical bearing 76, in other words does not lift off from it. In particular, the configuration of rotor 18 and the stator 86 is adapted in such a way that a magnetic force at one end of the rotor 18 is greater than at an opposing end, so a holding force results which, even in the event of a maximum counterforce, such as, for example, in the event of a hydraulic counterforce, presses the rotor 18 against the sliding body 80 of the spherical bearing 76. The electric motor 20 can thus be configured with a low overall height.

An electric motor of this type is described in DE 102 45 015 A1 and US 2003/0222527 A1, to which reference is expressly made.

The return body 88 is configured spherically, at least in segments, facing the rotor 18 for the spherical configuration of the stator 86. For example, the magnetic return body 88 is produced from a pressed powder material.

A corresponding electric motor is disclosed in EP 1 416 607 A2 or US 2004/0119371 A1, to which reference is expressly made.

The stator 86 has a region 90, which borders on the pump space 14 or is at least in thermal contact therewith. Additional heat from the electric motor 20 can thus be removed by means of the liquid flowing through the pump space 14. (A relatively large part of the heat flow goes from the stator 88 into the rotor region.)

The circulation pump 10 according to the invention functions as follows:

The housing 12 is a common housing for the pump part of the circulation pump 10 and the electric motor part of the circulation pump 10; the housing 12 forms the pump space 14 and the receiving space 42 for the electric motor 20. The housing 12 is, in particular, produced in one piece. It is preferably produced from a plastics material. A simple and economical producibility thus results.

The electric motor 20 is fixed in the housing 12 axially by means of the shoulder 46 and the holding element 62. The holding element 62 with its external thread engages in the internal thread 66 of the housing 12. A complete fixing is therefore achieved between the holding element 62 and the housing 12. The holding element 62 absorbs the axial bracing force to brace the electric motor 20 and the static and dynamic force in the receiving space 42.

The housing 12 can thus be configured so as to be thin-walled and plastics material can therefore be used as the housing material. As the holding element 62 also has to ensure an axial fixing, no, or only small, shear stresses occur.

The electric motor is radially fixed in the receiving space 42 by the motor housing 52.

By using a plastics material for the housing 12, substantially any shaping is possible for the housing 12; this is in contrast to cast iron housings. A housing shape can thus be used, by means of which an optimised degree of efficiency of the circulation pump 10 can be achieved.

The electric motor 20 has a low axial height, this axial height being substantially determined by the height of the rotor. Stator heat can thus be removed to the liquid to be pumped. This, in turn, sharply reduces the thermal load for a motor housing. A plastics material can thus be used for the housing for the electric motor 20, namely for the electric motor part 28 of the housing 12.

A circulation pump, which can be produced in a simple and economical manner and in which the degree of efficiency can be optimised by the housing shaping, is provided by the solution according to the invention.

The circulation pump 10 is produced according to the invention as follows:

The housing 12 is produced, in particular, from a plastics material, for example by an injection moulding method.

The electric motor 20 is produced separately and the pump impeller 16 is connected to the rotor 18 of the electric motor 20.

The electric motor 20 is then pushed by means of the open end 60 of the housing 12 into the housing 12. The electric motor 20 is automatically correctly positioned radially by means of its motor housing 52.

The stopper-like holding element 62 is then screwed on. This ensures the axial fixing of the electric motor 20 in connection with the shoulder 46 in the housing 12 and closes the housing 12.

The holding element 62, in this case, also closes the open end 60 of the housing 12, so a housing interior is closed toward the outer chamber.

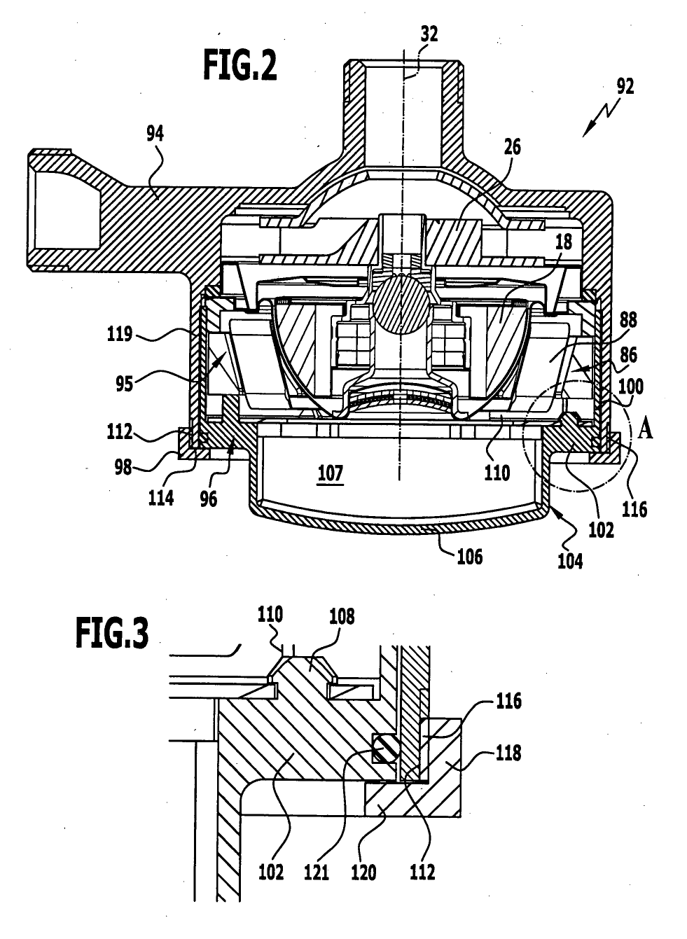

A second embodiment of a circulation pump according to the invention, which is shown in FIG. 2 and designated 92 there, comprises a housing 94, which is configured substantially the same as the housing 12 of the circulation pump 10. A difference of the housing 94 from the housing 12 is that an internal thread 66 is not provided. Otherwise, reference is made to the description of the housing 12.

An electric motor 95, which is basically configured the same with respect to its functional components as the electric motor 20 in the first embodiment 10, is arranged in the housing 94. The same reference numerals are therefore used for the same functional motor components as in the first embodiment 10.

A motor housing 96, on which a holding element 98 acts, is used to fix the electric motor 95 in the housing 94. The motor housing 96 (which holds the components of the electric motor together) has a cylindrical wall 100, by means of which a radial positioning and fixing of the electric motor 95 in the housing 94 is ensured.

The wall 100 is connected in one piece to an annular region 102, on which a further cylindrical region 104 is seated in one piece. When the electric motor 20 is fixed, an intermediate space 107 is formed between the electric motor 20 and a base 106 of the cylindrical region 104. This space may, for example, receive a control circuit for the circulation pump 92.

The annular region 102 projects over the housing 94 to such an extent that the holding element 98 can act on it; the electric motor 95 can thus be axially fixed.

One or more pins 108 are arranged, for example, on the annular region 102, by means of which pins a circuit board 110 is held (FIG. 3). In particular, the pin 108 is configured in relation to the circuit board 110 in such a way that the circuit board 110 can be fixed in the manner of a snap connection on the motor housing 96.

The motor housing 96 of the electric motor 95 is cup-shaped to ensure a radial positioning and fixing of the electric motor 95 in a corresponding receiving space of the housing 94 for the electric motor 95.

The motor housing 96, which is used to close the housing 94, is held on the housing 94 by the holding element 98. A holding element 98 is, for example, configured as a retainer nut. For this purpose, it has an internal thread 112. The housing 94, close to its end face end 114 has an external thread 116, which is adapted to the internal thread.112.

In cross-section, the holding element 98 is L-shaped (FIG. 3). The internal thread 112 is formed on a first holding element part 118. A second holding element part 120, which extends perpendicularly to the first holding element part 118, is used for resting the holding element 98 on an outer side of the annular region 102. The electric motor 95 can thus be axially fixed by means of the holding element 98 by its second holding element part 120. The motor housing 96 may be pressed, in particular, by means of the holding element 98 in the direction of a pump space of the housing 94, to thus brace the electric motor 95 in the housing 94 and to axially fix it.

The second holding element 120 of the holding element 98 overlaps the end face end 114 of the housing 94. This also ensures a seal, and specifically in the same manner as the flange 72 of the holding element 62 in the circulation pump 10 overlaps an end face of the housing 12.

The holding element 98 is in particular annular, with it surrounding the region 104. It acts as a retainer nut for axially fixing the electric motor 95.

In a variant of the circulation pump 92, a seal 121, for example in the form of an O-ring, is arranged between the annular region 102 and a housing wall 119, which forms the receiving space for the electric motor 95. This seal 121 is used to prevent the penetration of liquid into the receiving space. The corresponding circulation pump can then be used, for example, as an immersion pump.

Otherwise, the circulation pump 92 functions like the circulation pump 10 and can be produced in basically the same manner.

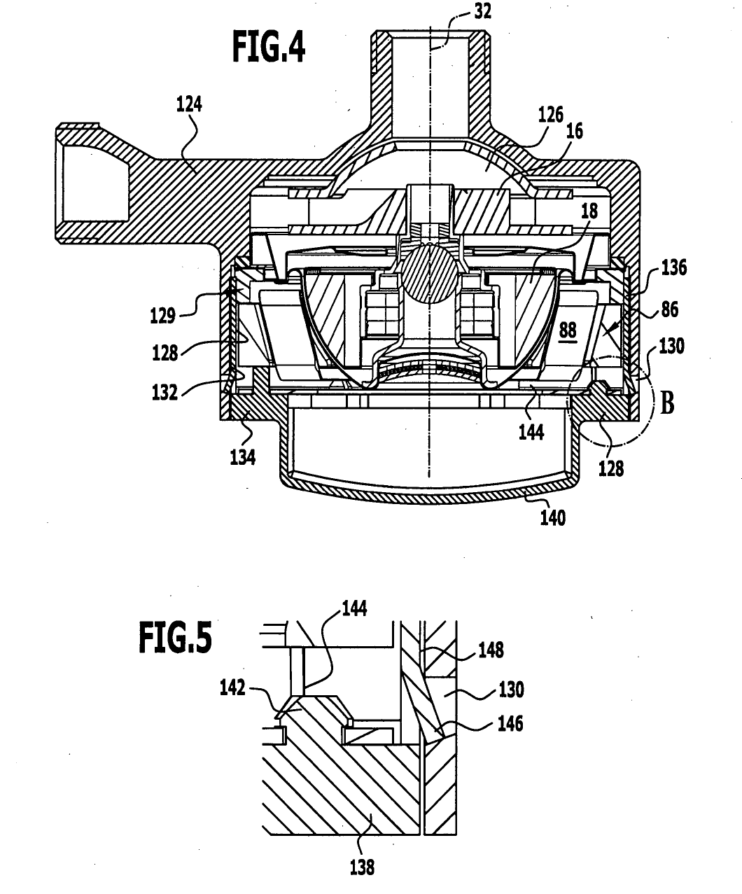

In a third embodiment, which is shown in FIG. 4 and designated 122, a housing 124 is provided, in which a pump space 126 is formed and which has a receiving space 128 for an electric motor 129. The electric motor 129 is basically configured the same with respect to its functional components as described with the aid of the embodiment. The same reference numerals are therefore used for the same functional components.

The housing 124 is basically configured the same as the housing 12, no internal thread 66 being provided.

The housing 124 is provided, in particular in the region of the receiving space 128, with a plurality of recesses 130 (FIG. 5).

The recesses 130 may be through recesses or only arranged as a depression on an inner side 132 of a housing wall of the housing 124, which forms the receiving space 128.

In the case of a plurality of recesses 130, they are located, in particular at the same axial height.

To fix the electric motor 129 in the housing 124, a correspondingly configured motor housing 134 is provided. The motor housing 134 forms a holding element 134. It comprises a cylindrical wall 136, which surrounds the electric motor 129 and, when the electric motor 129 is fixed, projects into an intermediate space between the electric motor 129 and the inner side 132 of the housing 124. The wall 136 is consequently used for the radial positioning and fixing of the electric motor 129 in the receiving space 128.

The cylindrical wall 136 is connected, in particular in one piece, to an annular region 138. A dome-like region 140 with a cylindrical inner space projects over the annular region 138. The motor housing 134 is basically configured the same here as the motor housing 96 in the second embodiment 92.

A plurality of pins 142 may be provided, which are immersed in corresponding recesses on a circuit board 144 and hold this circuit board 144 on the motor housing 134. The motor housing 134 is fixed in the associated electric motor 129 by means of pin/recess connections.

The motor housing 134 is provided with a plurality of tongues 146 as “intrinsic” holding elements, which, when the electric motor 129 is fixed, project into the corresponding recesses 130. The tongues 146 project over an outer face 148 of the cylindrical wall 136. They are elastically configured in such a way that the electric motor 129 with its motor housing 134 can be inserted into the receiving space 128. For this purpose, a force is necessary to hold the tongues 146 out of their basic position in the direction of the rotational axis 32. When the tongues 146 reach their associated recesses 130, they snap into the respective recesses 130. An axial fixing of the electric motor 129 in the receiving space 128 is thus achieved. A radial positioning and fixing takes place simultaneously owing to the cylindrical wall 136.

The tongue/recess combinations, for example, form a snap connection. The snap connection is thus configured, in particular, in such a way that after the fixing of the electric motor 129, the circulation pump 122 can no longer be disassembled, in other words the motor housing 134 can no longer be detached from the housing 124 without destruction. In the embodiments 10 and 92, on the other hand, the corresponding housing 12 and 94 can also be opened without destruction after assembly, in that the corresponding holding element 62 or 98 is released.

The tongues 146 and the recesses 130 form a clamping device 149 for clamping the electric motor 129 directly on the housing 124. It is thus basically also possible for the tongues to be arranged on the housing and the recesses on the electric motor 129.

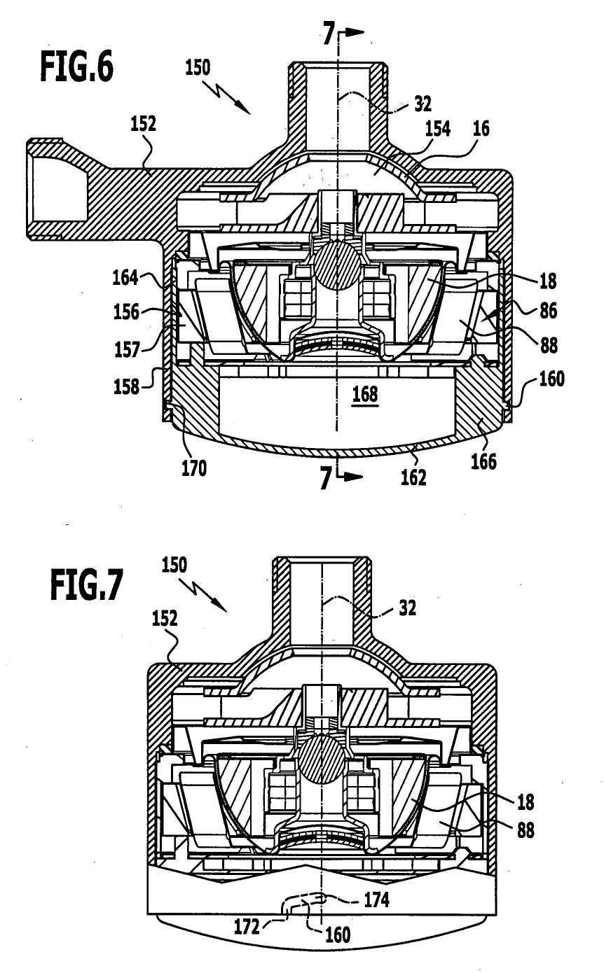

In a fourth embodiment, which is shown in FIGS. 6 and 7 and designated 150 there, a housing 152 is provided, which is substantially configured the same as the housing 12 of the circulation pump 10.

The housing 152 forms a pump space 154 and a receiving space 156 for an electric motor 157. The electric motor 157 is basically configured the same with respect to its functional components as described above with the aid of the first embodiment 10. The same reference numerals are therefore used for the corresponding functional components.

The housing 152, unlike the housing 12, has no internal thread. Furthermore, one or more groove-shaped recesses 160 are arranged on a cylindrical housing wall 158, which forms the receiving space 156. This recess or recesses 160 are used to form a bayonet connection with a holding element 162. The holding element 162 is formed here by a motor housing of the electric motor 157.

The electric motor 129 can be fixed and positioned axially and radially in the housing 152 by means of its holding element 162. For this purpose, the motor housing 162 has a cylindrical wall 164, which, when the electric motor 157 is fixed, at least in part regions, rests on an inner side of the wall 158 of the housing 152.

The wall 158 is formed on a base 166, which is used to close the housing 152 at an end remote from the pump space 154. In the base 166, a free space 168 may be formed, in order, for example, to receive an electronic control circuit for the circulation pump 150.

One or more groove pins 170, which may project into the associated recesses 160, are seated on the base 166, and adapted to the recess or recesses 160.

The groove-shaped recesses 160 and the groove pins 170 are arranged and configured adapted to one another in such a way that the groove pins 170, when the holding element 162 with the electric motor 157 (on which it is fixed by means of one or more pins) is inserted into the housing 152, can project into the recesses 160 and an axial displacement of the electric motor 157 up to its desired end position is possible. This axial displacement is brought about here by a rotation of the holding element 162. During this rotation, the groove pins 170 are guided in their recesses 160 in such a way that a fixing of the electric motor 157 in its desired axial position is made possible.

In order to be able to insert the groove pins 170, the associated recesses 160 have an aperture region 172 (FIG. 7), which leads to an end face end of the housing 152. This aperture region 172 is substantially aligned parallel to the rotational axis 32. Adjoining this aperture region 172 is a transverse region 174, which is located at an angle to the rotational axis 32 to allow a rotation and thus an axial displacement of the holding element 162.

The groove pin/recess connection is configured in the manner of a bayonet connection. The electric motor 157 can thus be inserted and fixed in the housing.

Otherwise the circulation pump 150 functions as described above.

1. Circulation pump, comprising:
a housing, in which a pump space is arranged,
a pump impeller, which is. rotatable about a rotational axis; and
an electric motor to drive the pump impeller;
wherein the housing has a receiving space for the electric motor.

2. Circulation pump according to claim 1, wherein the housing has an axial extent in relation to the rotational axis to form the receiving space for the electric motor.

3. Circulation pump according to claim 1, wherein the housing is produced from a plastics material.

4. Circulation pump according to claim 1, wherein the housing is configured in one piece.

5. Circulation pump according to claim 1, wherein the pump space and the receiving space for the electric motor are arranged axially one after the other in the housing.

6. Circulation pump according to claim 1, wherein a fixing device is provided at least for the axial fixing of the electric motor in the housing.

7. Circulation pump according to claim 6, wherein the electric motor is fixed by bracing by means of the fixing device in the housing.

8. Circulation pump according to claim 6, wherein the fixing device has one or more holding elements, which are fixed on the housing and by means of which the electric motor is held in position.

9. Circulation pump according to claim 8, wherein the at least one holding element is fixed on the housing by means of a housing periphery or at least an interconnected part region of a housing periphery.

10. Circulation pump according to claim 9, wherein the at least one holding element is fixed to the housing along the entire periphery.

11. Circulation pump according to claim 8, wherein the at least one holding element is provided with a thread and the housing is provided with a corresponding thread.

12. Circulation pump according to claim 11, wherein the at least one holding element is provided with an external thread and the housing is provided with an internal thread.

13. Circulation pump according to claim 11, wherein the at least one holding element projects into the housing.

14. Circulation pump according to claim 11, wherein the at least one holding element has an internal thread and the housing has an external thread.

15. Circulation pump according to claim 8, wherein the electric motor has one or more contact faces for the at least one holding element.

16. Circulation pump according to claim 15, wherein the at least one contact face projects over the housing.

17. Circulation pump according to claim 8, wherein the at least one holding element is a separate component from the electric motor.

18. Circulation pump according to claim 8, wherein the at least one holding element is arranged on the electric motor.

19. Circulation pump according to claim 18, wherein the at least one holding element is formed by means of a motor housing of the electric motor.

20. Circulation pump according to claim 8, wherein the at least one holding element is fixed by means of a clamping device on the housing.

21. Circulation pump according to claim 20, wherein the clamping device has at least one tongue, which is arranged on at least one of the at least one holding element and the housing, and has at least one adapted recess, which is arranged on at least one of the housing and the at least one holding element, the at least one holding element being at least axially fixed on the housing by projection of the at least one tongue into the associated recess.

22. Circulation pump according to claim 8, wherein the at least one holding element is fixed to the housing by means of a bayonet connection.

23. Circulation pump according to claim 8, wherein one or more seals are arranged between the at least one holding element and the housing.

24. Circulation pump according to claim 1, wherein a contact face is configured on the housing to support the electric motor.

25. Circulation pump according to claim 24, wherein the contact face is formed on a shoulder in an interior of the housing.

26. Circulation pump according to claim 1, wherein the receiving space and the electric motor are configured so as to be adapted in such a way that the electric motor is radially fixed by resting on inner wall regions of the housing.

27. Circulation pump according to claim 1, wherein the electric motor has a spherically mounted rotor.

28. Circulation pump according to claim 1, wherein the rotor is configured so as to produce a magnetic field.

29. Circulation pump according to claim 28, wherein the rotor is configured spherically facing a stator.

30. Circulation pump according to claim 28, wherein the stator is configured spherically facing the rotor.

31. Circulation pump according to claim 28, wherein a magnetic return body of the stator annularly surrounds the rotor.

32. Circulation pump according to claim 31, wherein the magnetic return body is produced from a pressed powder material.

33. Circulation pump according to claim 29, wherein a height of the stator substantially corresponds to the height of the rotor or has a smaller height than the height of the rotor.

34. Circulation pump according to claim 1, wherein a rotor and a stator of the electric motor are configured so as to be adapted in such a way that an axial magnetic holding force, which holds the rotor on a spherical bearing, is greater than a maximum axial counterforce.

35. Circulation pump according to claim 1, wherein the electric motor is arranged and configured in such a way that heat can be removed from it by means of the liquid to be pumped.

36. Circulation pump according to claim 35, wherein a stator of the electric motor is in thermal contact with the pump space.

37. Method for producing a circulation pump, comprising:
producing a housing with a pump space and a receiving space for an electric motor; and
inserting the electric motor into this housing.

38. Method according to claim 37, wherein the housing is produced from a plastics material.

39. Method according to claim 37, wherein the electric motor is fixed axially by means of one or more holding elements, the at least one holding element being fixed on the housing.

40. Method according to claim 39, wherein the housing is closed by means of the at least one holding element.

41. Method according to claim 39, wherein the at least one holding element is fixed to the housing by means of a peripheral region of the housing.

42. Method according to claim 38, wherein, by resting on the housing, the electric motor is radially positioned therein.
